(19) United States
(12) Patent Application Publication
(10) Pub. No.: US 2012/0026105 A1
(43) Pub. Date: Feb. 2, 2012

(54) ELECTRONIC DEVICE AND METHOD THEREOF FOR TRANSMITTING DATA

(75) Inventors: HO-LEUNG CHEUNG, Santa Clara, CA (US); PING-YANG CHUANG, Tu-Cheng (TW)

(73) Assignee: HON HAI PRECISION INDUSTRY CO., LTD., Tu-Cheng (TW)

(21) Appl. No.: 12/978,618

(22) Filed: Dec. 26, 2010

(30) Foreign Application Priority Data
Jul. 28, 2010 (TW) 99124908

(51) Int. Cl. G06F 3/041

(52) U.S. Cl. 345/173

(57) ABSTRACT

An electronic device includes a touch screen, a storage unit storing a plurality of electronic files and relationships between display contacts and functions, and a processing unit. The touch screen produces contact signals in response to user's display contacts. The processing unit detects the user's display contacts according to the contact signals, determines a function corresponding to the user's display contact according to the relationships, and determines the function is a data transmitting function when the display contact is a pre-defined corresponding contact. The processing unit further determines an electronic file displayed on the touch screen and transmits the determined electronic file, when determining the function is the data transmitting function.

### BACKGROUND

1. Technical Field

The present disclosure relates to data management and, particularly, to an electronic device with touch input and method for transmitting data based on the touch input.

2. Description of Related Art

Touch-enabled devices are in widespread use. However, if, during playback or display of content, transfer of the content to another device is desired, the current operation often needs to be abandoned, which is inconvenient.

Therefore, it is desirable to provide an electronic device and a method to overcome the described limitations.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of an electronic device, in accordance with an exemplary embodiment.

FIG. 2 is a block diagram of the electronic device of FIG. 1, in accordance with an exemplary embodiment.

FIGS. 3A-3B are schematic diagrams illustrating a process of defining display contact, in accordance with an exemplary embodiment.

FIG. 4 is a schematic diagram illustrating a data transmission interface of the device of FIG. 1.

FIG. 5 is a flowchart illustrating a method for transmitting data applied in an electronic device, such as, for example, that of FIG. 1, in accordance with an exemplary embodiment.

### DETAILED DESCRIPTION

Embodiments of the present disclosure will now be described in detail, with reference to the accompanying drawings.

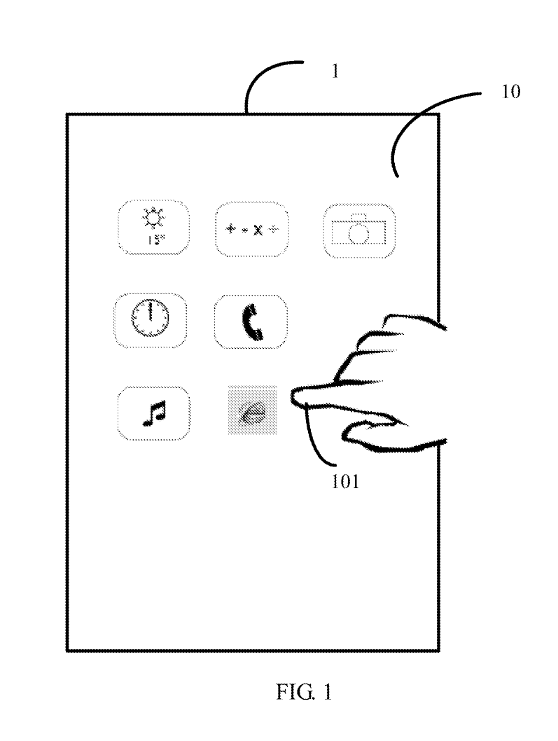

Referring to FIG. 1, an electronic device 1 capable of transmitting data directly is provided in accordance with an exemplary embodiment. The electronic device 1 includes a touch screen 10. The touch screen 10 displays a graphical user interface (GUI) which includes a number of icons corresponding to various operations. The operations are implemented in response to contact with the corresponding icon. In the embodiment, the touch screen 10 is a multi-point touch screen capable of producing contact signals in response to display contact. In other embodiments, the electronic device 1 further includes physical controls.

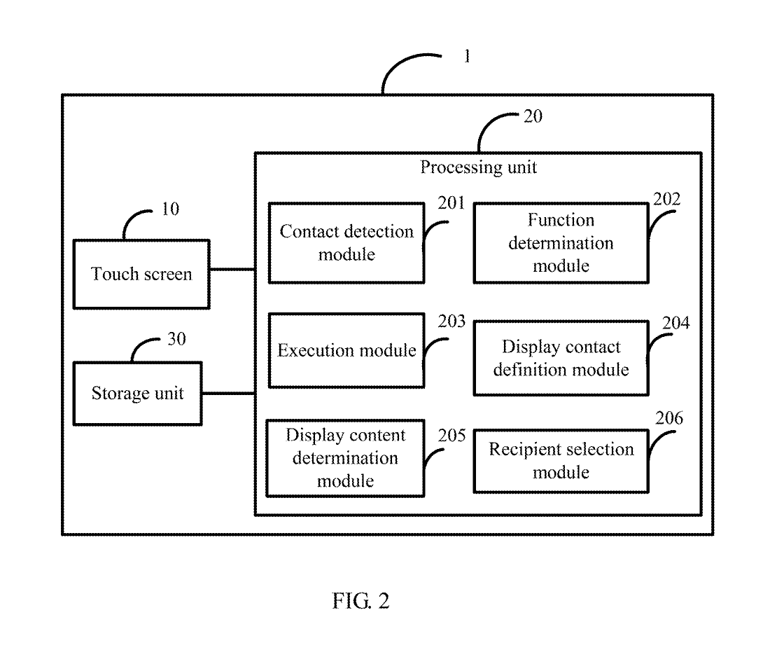

Referring to FIG. 2, the electronic device 1 further includes a processing unit 20 and a storage unit 30. The storage unit 30 stores electronic files, which include, but are not limited to, audio files, videos, digital images, texts, and others. The storage unit 30 further stores relationships between functions and display contacts (hereinafter “display contact-function relationships”).

The processing unit 20 includes a contact detection module 201, a function determination module 202, and an execution module 203. The contact detection module 201 receives the contact signals from the touch screen 10 and detects a corresponding display contact. The function determination module 202 determines a function corresponding to the detected display contact according to the display contact-function relationships. The execution module 203 executes the determined function.

The display contact-function relationships can be provided as a system default setting. For example, a display contact comprising contact for a predetermined time and then moving contact can be recognized as representing data transmission in the system default setting. In the embodiment, the processing unit 20 further includes a display contact definition module 204 for defining the display contact-function relationships. The electronic device 1 further provides a definition mode allowing pre-defining of the display contact-function relationships. For example, the electronic device 1 provides an icon or menu item allowing entry to definition mode. When the electronic device 1 enters the definition mode, the display contact definition module 204 directs the touch screen 10 to display icons of the electronic device 1 for selection, requests definition of the display contact for a selected function, and stores the defined display contact associated with the function in the storage unit 30.

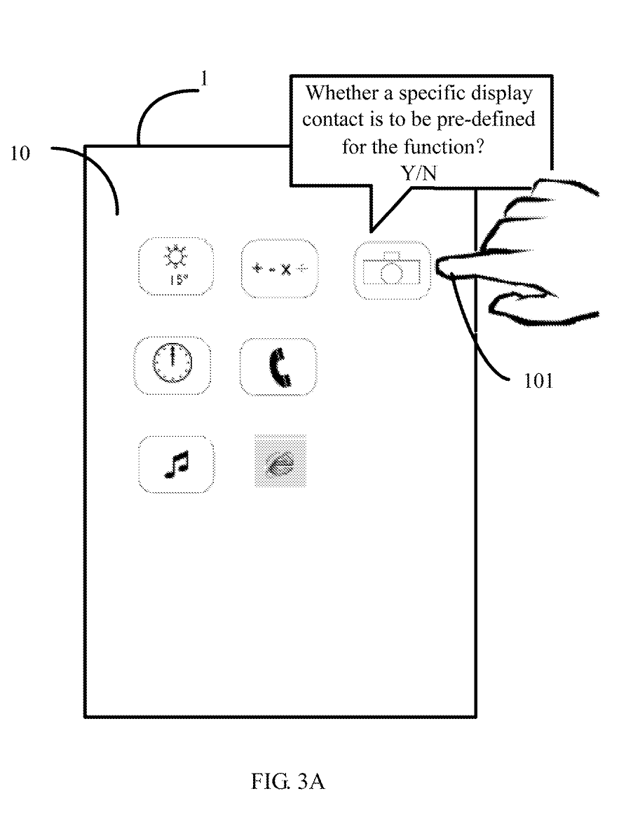

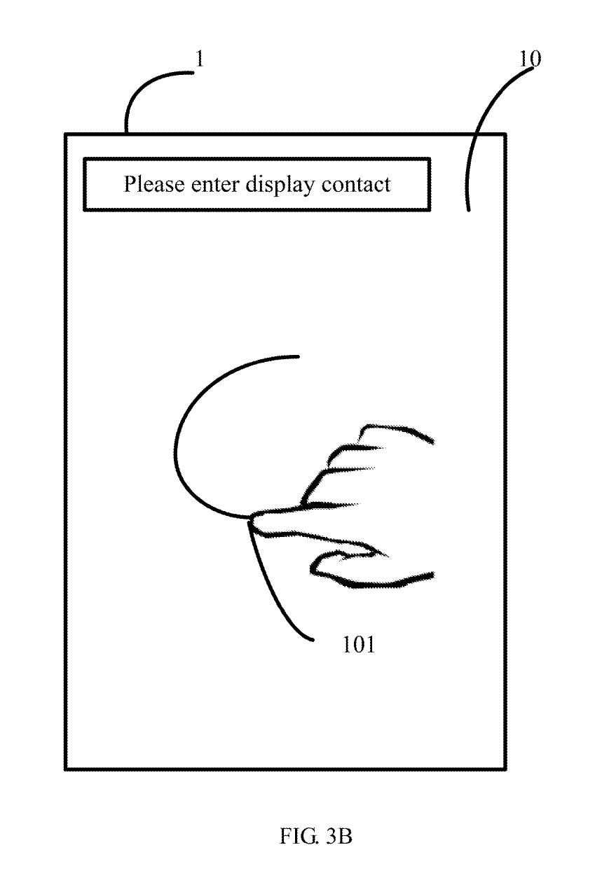

Referring to FIG. 3A, when the electronic device 1 enters the definition mode, the display contact definition module 204 directs the touch screen 10 to display the icons for selection. If a camera icon is selected, the display contact definition module 204 directs the touch screen to inquire whether a specific display contact is to be pre-defined for the function. If Yes is chosen, the display contact definition module 204 directs the touch screen 10 to display an interface as shown in FIG. 3B. Referring to FIG. 3B, when, for example, a C shape display contact is entered, the display contact definition module 204 stores the specific display contact associated with the camera function in the storage unit 30, after which, execution of the C shape display contact executes the camera function.

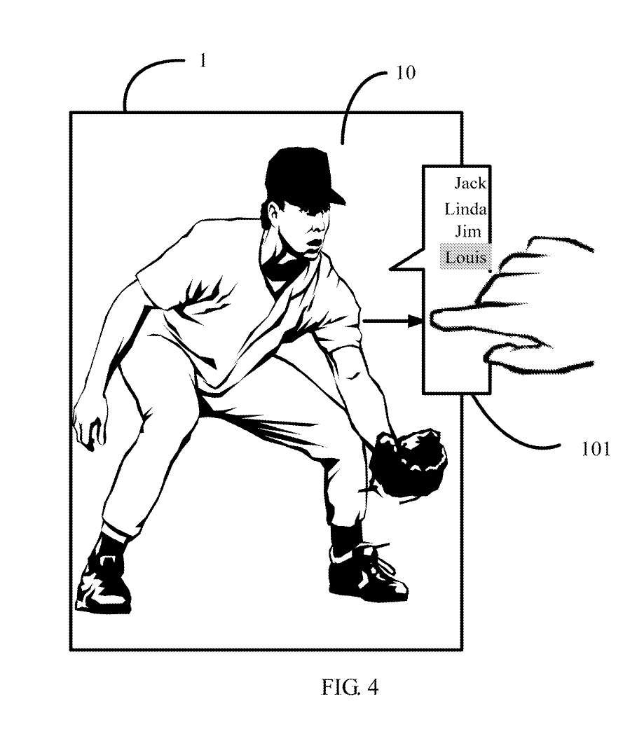

The processing unit 20 further includes a display content determination module 205, and a recipient selection module 206. Referring also to FIG. 4, during display of an electronic file, such as an image as shown in FIG. 4, if the contact detection module 201 detects a specific display contact such as prolonged contact followed by a slide, the function determination module 202 determines the function corresponding to the display contact is a data transmitting function. The function determination module 202 transmits a data transmitting signal to the display content determination module 205 and the recipient selection module 206 respectively. The display content determination module 205 registers the currently active electronic file (namely the display content determination module determines the currently active electronic file), and the recipient selection module 206 directs the touch screen 10 to display an address list stored in the storage unit 30.

As shown in FIG. 4, the recipient selection module 206 transmits a send signal to the execution module 203 after at least one recipient is selected. The execution module 203 transmits the electronic file determined by the display content determination module 205 to the at least one selected recipient when receiving the send signal. In the embodiment, the address list includes all of the contacts of the electronic device 1. In other embodiment, the address list only includes some of the contacts preselected by the user. In the embodiment, the address list displayed on the touch screen uses a form of a dialog box.

Therefore, in the embodiment, when the user enjoys one electronic file and wants to transmit the electronic file to other people, he/she can transmit the electronic file to the selected people by touching the touch screen 1 directly.

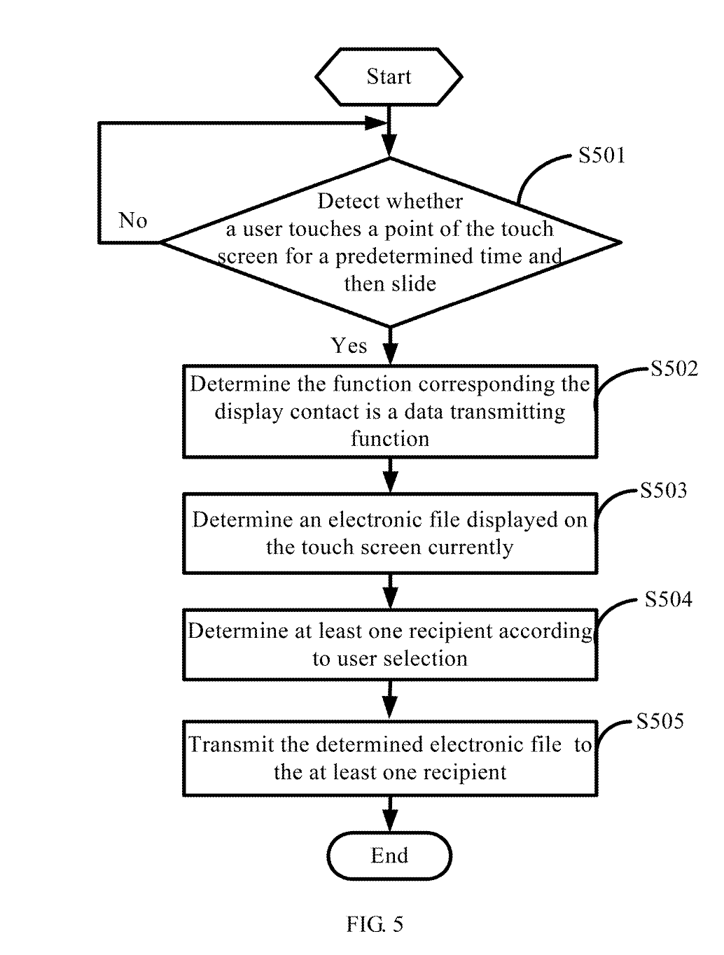

FIG. 5 is a flowchart illustrating a method for transmitting data of an electronic device such as, for example, that of FIG. 1. In step S501, the display contact detection module 101 detects whether the user touches a point of the touch screen 10 for a predetermined time and then slide on the touch screen 10.

If not, the process returns to step S501, if yes, in step S502, the function determination module 202 determines the function corresponding the display contact is a data transmitting function.

In step S503, the display content determination module 205 determines an electronic file displayed on the touch screen currently, namely the display content determination module 205 determines the currently active electronic file.

In step S504, the recipient selection module 206 determines at least one recipient receiving the electronic file according to user's selection. In detail, the recipient selection module 206 directs the touch screen 10 to display an address list for selection, and determines at least one recipient according to the user's selection from the address list.

In step S505, the execution module 203 transmits the electronic file determined by the display content determination module 205 to the at least one recipient determined by the recipient selection module 206.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. An electronic device comprising:
a touch screen, configured to produce contact signals in response to user's display contacts;
a storage unit storing a plurality of electronic files and relationships between display contacts and functions of the electronic device;
a processing unit comprising:
a contact detection module configured to detect the user's display contacts according to the contact signals;
a function determination module configured to determine a function corresponding to the user's display contact according to the relationships, and determine the function is a data transmitting function when the display contact is a pre-defined corresponding contact, and produce a data transmitting signal;
a display content determination module configured to determine an electronic file displayed on the touch screen when receiving the data transmitting signal;
an execution module configured to execute the function determined by the function determination module, and transmit the electronic file determined by the display content determination module, when the function determined by the function determination module is the data transmitting function.

2. The electronic device according to claim 1, wherein the processing unit further comprises a recipient selection module, which is configured to determine at least one recipient according to the user's selection; the execution module transmits the electronic file determined by the display content determination module to the at least one recipient determined by the recipient selection module, when the function determined by the function determination module is the data transmitting function.

3. The electronic device according to claim 2, wherein the recipient selection module directs the touch screen to display an address list for selection, and determines the at lease one recipient according to the user's selection, when receiving the data transmitting signal.

4. The electronic device according to claim 3, wherein the address list includes all of contacts of the electronic device.

5. The electronic device according to claim 3, wherein the address list includes some of the contacts of the electronic device preselected by the user.

6. The electronic device according to claim 3, wherein the address list displayed on the touch screen uses a form of a dialog box.

7. The electronic device according to claim 1, wherein the processing unit further comprises a display contact definition module, when the electronic device enters a definition mode in response to user's operation; the display contact definition module directs the touch screen to display the function icons of the electronic device for selection, prompts the user to define the display contact for a selected function, and stores the defined display contact associated with the function in the storage unit.

8. The electronic device according to claim 1, wherein the touch screen is a multi-point touch screen.

9. A method for transmitting data of an electronic device, the electronic device comprises a touch screen and a storage unit storing electronic files, the method comprising:
detecting whether the user touches a point of the touch screen for a predetermined time and then slide on the touch screen;
determining the function is a data transmitting function when detecting the user touches a point of the touch screen for a pre-defined corresponding contact;
determining an electronic file displayed on the touch screen; and
transmitting the electronic file.

10. The method according to claim 9, wherein the step “transmitting the electronic file” comprises:
determining at least one recipient receiving the electronic file according to user's selection; and
transmitting the electronic file to the at least one recipient.

11. The method according to claim 10, wherein the step “determining a recipient receiving the electronic file according to user's selection” comprises:
controlling the touch screen to display an address list;
determining the at least one recipient according to the user's selection from the address list.

12. The method according to claim 9, wherein the pre-defined contact comprises a contact of predetermined time and then a slide.
